(19) United States
(12) Patent Application Publication
(10) Pub. No.: US 2007/0021572 A1
(43) Pub. Date: Jan. 25, 2007

(54) Diamine compound polymer having 1,3-phenylene group

(75) Inventors: Daisuke Okuda, Kanagawa (JP); Katsuhiro Sato, Kanagawa (JP); Koji Horiba, Kanagawa (JP); Kiyokazu Mashimo, Kanagawa (JP); Takeshi Agata, Kanagawa (JP); Toru Ishii, Kanagawa (JP); Tadayoshi Ozaki, Kanagawa (JP); Hidekazu Hirose, Kanagawa (JP); Hirohito Yoneyama, Kanagawa (JP); Mieko Seki, Kanagawa (JP); Yohei Nishino, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/399,951

(22) Filed: Apr. 7, 2006

(30) Foreign Application Priority Data
Jun. 27, 2005 (JP) 2005-187474

(51) Int. Cl. C08F 20/00

(52) U.S. Cl. 525/443

(57) ABSTRACT

The invention provides a diamine compound polymer having a 1,3-phenylene group selected from structural formulae represented by formulae (I-1) and (I-2): 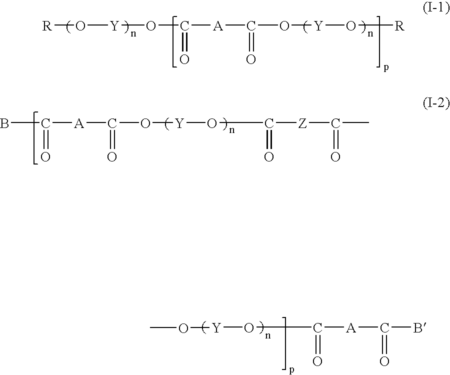
where, in the formulae (I-1) and (I-2), A represents a structure represented by the following formula (II); R represents a hydrogen atom, an alkyl group, a substituted or non-substituted aryl group, or a substituted or non-substituted aralkyl group; Y represents a divalent alcoholic residue; Z represents a divalent carboxylic acid residue; B and B′ independently represent —O—(Y—O)ₙ—R or —O—(Y—O)ₙ—CO—Z—CO—O—R′ (where R, Y and Z have the same meanings as described above, and R′ represents an alkyl group, a substituted or non-substituted aryl group, or a substituted or non-substituted aralkyl group); n represents an integer of 1 to 5; and p represents an integer of 5 to 5000; 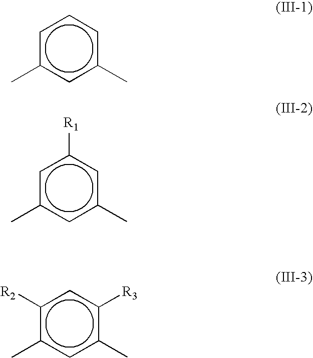 where, in the formula (II), Ar represents a substituted or non-substituted aromatic group; X represents a substituted or non-substituted divalent 1,3-phenylene group; T represents a divalent linear hydrocarbon group having 1 to 6 carbon atoms or a branched hydrocarbon group having 2 to 10 carbon atoms; and k and m represent an integer of 0 or 1, respectively.

### CROSS REFERENCE TO RELATED APPLICATION

This application claims priority under 35USC 119 from Japanese Patent Application No. 2005-187474, the disclosure of which is incorporated by reference herein.

### BACKGROUND

1. Field of the Invention

The present invention relates to diamine compound polymer having a 1,3-phenylene group, which are applicable to various organic electronic devices such as organic electroluminescence elements, electrophotographic photosensitive bodies, organic thin film transistors and organic semiconductor lasers and are excellent in charge transporting ability and light emission characteristics.

2. Description of the Related Art

Related Art

Charge transporting polymers represented by polyvinyl carbazole (PVK) are promising materials as photoconductive materials for electrophotographic photosensitive bodies and materials for organic electroluminescent elements as described in references known in the art (for example, see Proceedings of 37th Joint Meeting of The Japanese Society of Applied Physics, 31P-G-12(1990)). Application of these charge transporting polymers to various organic electronic devices, such as organic thin film transistors and organic semiconductor lasers, is expected.

These charge transporting polymers are formed as layers and are used as charge transport materials in the electrophotographic photosensitive bodies and organic electroluminescence elements. Such charge transport materials known in the art include charge transporting polymers represented by PVK, and dispersed low molecular charge transport materials including a charge transporting low molecular compound dispersed in a resin. The organic electroluminescence element is usually prepared by depositing a low molecular charge transport material in a vacuum.

Since various materials may be selected for constituting the dispersed low molecular charge transport materials and high performance materials can be readily obtained, the low molecular charge transport material is mainly used in the electrophotographic photosensitive bodies.

While the electrophotographic photosensitive body has been used for high speed copy machines and printers in accordance with high performance of organic photosensitive bodies, current performance is not always sufficient, and more prolonged service life is urgently desired.

In view of sensitivity and durability, it is mainstream for this organic photosensitive body to be a stacked type, in which the charge transporting layer is disposed on the outermost surface. This charge transport layer is formed from the dispersed low molecular charge transport material, and charge transport layers with sufficiently satisfactory performance with respect to electrical characteristics can be obtained. However, the low molecular charge transport material is poor in compatibility with a resin component constituting a matrix and the low molecular charge transport material decreases the intrinsic mechanical strength of the resin. Therefore, the charge transport layer provided on the surface of the organic photosensitive body intrinsically has poor mechanical strength and is weak with respect to abrasion.

To solve these problems, introducing an alkylene carboxylic acid ester group into the low molecular charge transport material to improve compatibility of the low molecular charge transport material with the resin component has been proposed (Japanese Patent Application Laid-Open (JP-A) Nos. 63-113465 and 5-80550). However, even though compatibility with the resin is improved, the low molecular charge transport material in which the alkylene carboxylic acid ester group is introduced tends to be difficult to crystallize due to a high freedom of molecular motion of the alkylene carboxylic acid ester group itself. Accordingly, industrial scale production of the low molecular charge transport material in which the alkylene carboxylic acid ester group is introduced is difficult and, because it is difficult to purify this charge transport material to a high degree, purification methods, such as chromatography, are necessary. Moreover, since the alkylene carboxylic acid ester group is electron attractive, mobility of charges tends to be decreased.

On the other hand, a large amount of Joules of heat is generated since the organic electroluminescence element is energized with a current density as high as several mA/cm². Morphology changes are liable to occur by crystalization of the low molecular charge transport material due to the large amount of heat generated when the dispersed low molecular charge transport material is used for the charge transport material of the organic electroluminescence element. Consequently, undesirable phenomena such as a decrease of luminance and dielectric breakdown are caused, resulting in a decrease of the service life of the element.

It has also been a problem from the view point of efficiency and service life that a material having both a charge transporting ability and a luminous property can be hardly obtained by conventional polymer materials. On the contrary, the charge transporting polymer is being actively studied since it has a possibility of greatly improving the drawbacks described above.

Examples of such a charge transporting polymer include polycarbonate synthesized by polymerization of a specified dihydroxydiarylamine and bischloroformate (see U.S. Pat. No. 4,806,443), polycarbonate synthesized by polymerization of a specified dihydroxyarylamine and phosgene (see U.S. Pat. No. 4,806,444), polycarbonate synthesized by polymerization of bishydroxyarylamine and bischloroformate or phosgene (see U.S. Pat. No. 4,801,517), polycarbonate from polymerization of a specified dihydroxydiarylamine and bishydroxyalkylarylamine, or bishydroxyalkylamine and bischloroformate, and polyester from polymerization with bisacylhalide (see U.S. Pat. Nos. 4,937,165 and 4,959,228).

Further examples include polycarbonate or polyester (see U.S. Pat. No. 5,034,296) or polyurethane (see U.S. Pat. No. 4,983,482) of arylamine having a specified fluorene skeleton; polyester having a specified bisstyrylbisarylamine as a main chain (see Japanese Patent Application Publication (JP-B) No. 59-28903); and polymers and photosensitive bodies having charge transporting substituents, such as hydrazone and triarylamine, as pendants (see JP-A Nos. 61-20953, 1-134456, 1-134457, 1-134462, 4-133065 and 4-133066).

Examples of applications of the organic electroluminescence element include organic electroluminescence elements using 7r-conjugate polymers represented by paraphenylenevinylene (PPV; Nature, Vol. 357, 477, 1992), and organic electroluminescence elements using polymers having triphenylamine introduced into the side chain of polyphosphazene (Proceedings of the b 42^{nd} Polymer Forum 20J21, 1993).

A lot of attention has been paid to organic semiconductors in recent years as a third semiconductor technology following silicone and compound semiconductors. Since organic transistors manufactured by taking advantage of this organic semiconductor technology are flexible, they can be used for low-end mobile information terminals such as electronic paper and printable information tags, and research and development of the organic semiconductor have been actively carried out in recent years.

Furthermore, technologies related to fiber-to-the-home (FTTH), which enables low-cost and large capacity transfer of information to ordinary homes, are being actively studied in the field of communication. Expectations for the organic semiconductor laser as a variety of cheap laser light source as one of these technologies are increasing, and the charge transporting polymer is expected to be applied to the organic transistor and organic semiconductor laser.

While various characteristic such as solubility, film deposition ability, charge mobility (mobility), heat resistance and matching of oxidation potential are required for the charge transporting polymer depending on its application, the properties have been usually controlled by introducing substituents. Since the property of the charge transporting polymer is correlated with the property of the charge transport monomer as a starting material, molecular design of the charge transport monomer is important.

For example, while the monomers as the starting materials of the triarylamine polymer described above are roughly classified into two groups of (1) dihydroxy arylamine and (2) bishydroxyalkyl arylamine, purification of dihydroxy arylamine is difficult since it has a readily oxidized aminophenol structure. Particularly, the compound becomes more unstable when it has a parahydroxy-substituted structure.

Moreover, since the compound has a structure in which oxygen is directly substituted to the aromatic ring, charge distribution tends to be biased due to the electron attracting property of the group, and mobility of the molecule is liable to be reduced.

On the other hand, with respect to bishydroxyalkyl arylamine, although the effect of the electron attracting property of oxygen is canceled with the methylene group, synthesis of the monomer is difficult. Since both bromine and iodine are reactive in the reaction between diarylamine or diarylbenzidine and 3-bromoiodobenzene, the product tends to be a mixture to cause a decrease of reaction yield. In addition, since alkyllithium and ethylene oxide used for substituting bromine with lithium is dangerous and highly toxic, careful handling of these compounds is required.

The π-conjugate polymers represented by paraphenylenevinylene (PPV) described above, and the organic electroluminescence elements taking advantage of the charge transporting polymers having triphenylamine introduced into the polyphosphazene side chain involve the problems of color tone, luminous intensity and durability.

As described above, most of the conventional charge transfer polymers have not reached satisfactory levels with respect to at least any one of characteristic properties of charge transfer materials such as readiness of synthesis, stability as starting materials, no toxicity and charge mobility. In other word, the conventional materials have not attained compatibility among basic properties required for the charge transfer material (such as charge mobility, matching of oxidation potential, quantum efficiency, film deposition ability and durability) as well as productivity, stability and handling performance in high levels. In addition, when the materials are used for organic electronic devices taking advantage of the charge transfer materials such as organic electroluminescence elements, they could not fully comply with these uses.

Accordingly, it is desirable to develop charge transfer materials that are readily synthesized and excellent in basic properties required for the charge transfer material, in order to develop an organic electronic device having excellent properties without any practical problems (for example, the organic electroluminescence element should have large luminance with stability for repeated uses, and the organic transistor is required to have high charge transfer ability in order to exhibit characteristic features excellent in responding ability.

### SUMMARY

The present invention has been made in view of the above circumstances and provides diamine compound polymer having 1,3-phenylene group.

According to an aspect of the invention, diamine compound polymers having a 1,3-phenylene group selected from structural formulae represented by formulae (I-1) and (I-2) is provided.

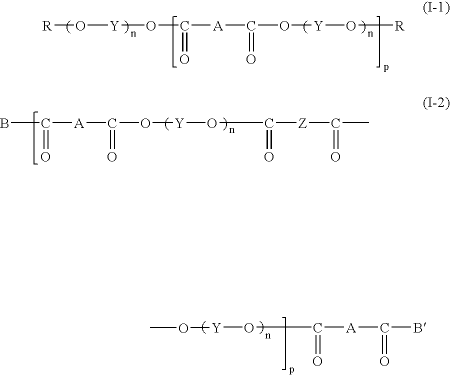

In the formulae (I-1) and (I-2), A represents a structure represented by the following formula (II); R represents a hydrogen atom, an alkyl group, a substituted or non-substituted aryl group, or a substituted or non-substituted aralkyl group; Y represents a divalent alcoholic residue; Z represents a divalent carboxylic acid residue; B and B′ independently represent —O—(Y—O)ₙ—R or —O—(Y—O)ₙ—CO—Z—CO—OR′ (where R, Y and Z have the same meanings as described above, and R′ represents an alkyl group, a substituted or non-substituted aryl group, or a substituted or non-substituted aralkyl group); n represents an integer of 1 to 5; and p represents an integer of 5 to 5000.

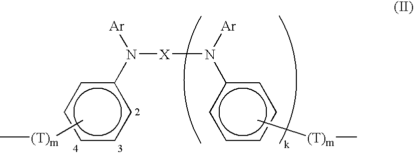

In the formula (II), Ar represents a substituted or non-substituted aromatic group; X represents a substituted or non-substituted divalent 1,3-phenylene group; T represents a divalent linear hydrocarbon group having 1 to 6 carbon atoms or a branched hydrocarbon group having 2 to 10 carbon atoms; and k and m represent an integer of 0 or 1, respectively.

### BRIEF DESCRIPTION OF THE DRAWINGS

FIG. 1 shows an IR spectrum of the compound obtained in Synthesis Example 1;

FIG. 2 shows an IR spectrum of the compound obtained in Synthesis Example 2;

FIG. 3 shows an IR spectrum of the compound obtained in Synthesis Example 3;

FIG. 4 shows an IR spectrum of the compound obtained in Synthesis Example 4;

FIG. 5 shows an IR spectrum of compound 10;

FIG. 6 shows an IR spectrum of compound 23;

FIG. 7 shows an IR spectrum of compound 16; and

FIG. 8 shows an IR spectrum of compound 21.

### DETAILED DESCRIPTION

The present invention can provide a diamine compound polymer having a 1,3-phenylene group that is able to be applied to various organic electronic devices such as organic electroluminescence element, photosensitive materials for electronic photograph, field effect transistors and semiconductor lasers, wherein basic properties required in the charge transfer material, such as charge mobility, matching of oxidation potential, quantum efficiency, film deposition ability and durability as well as productivity, stability and handling performance, may be compatible to one another in high levels in the invention.

The invention provides diamine compound polymers having a 1,3-phenylene group selected from structural formulae represented by following formulae (I-1) and (I-2).

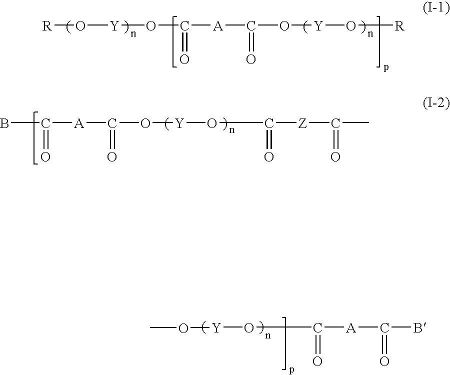

Since the diamine compound polymer having the 1,3-phenylne group represented by the formulae above is excellent in solubility in various solvents and antioxidative property, the polymers can be readily produced and are excellent in stability and handling performance. Since deviation of the electron density in the molecule is small (see, for example, Journal of the Society of Photographic Science and Technology of Japan, Vol. 29, No. 4, 366 (1990)), the polymer is able to display excellent properties, particularly good charge mobility.

In the formulae (I-1) and (I-2), A represents a structure represented by the following formula (II); R represents a hydrogen atom, an alkyl group, a substituted or non-substituted aryl group, or a substituted or non-substituted aralkyl group; Y represents a divalent alcoholic residue; Z represents a divalent carboxylic acid residue; B and B′ independently represent —O—(Y—O)ₙ—R or —O—(Y—O)ₙ—CO—Z—CO—O—R′ (where R, Y and Z have the same meanings as described above, and R′ represents an alkyl group, a substituted or non-substituted aryl group, or a substituted or non-substituted aralkyl group); n represents an integer of 1 to 5; and p represents an integer of 5 to 5000.

A preferable structural formula (formula (II)) representing A in formulae (I-1) and (I-2) is shown below.

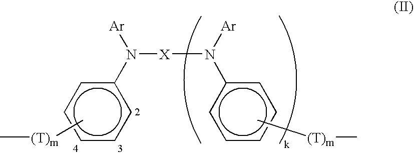

In the formula (II), Ar represents a substituted or non-substituted monovalent aromatic group.

More specifically, Ar represents a substituted or non-substituted phenyl group, a substituted or non-substituted monovalent polycyclic aromatic hydrocarbon with 2 to 10 aromatic rings, a substituted or non-substituted monovalent condensed ring aromatic hydrocarbon with 2 to 10 aromatic rings, a substituted or non-substituted monovalent aromatic heterocycle, or a substituted or non-substituted monovalent aromatic group including at least an aromatic heterocycle.

In the formula (II), a number of the aromatic rings constituting the polycyclic aromatic hydrocarbon or the condensed ring aromatic hydrocarbon, selected as a structure represented by Ar, is not particularly restricted, but is preferably 2 to 5, and, in case of the condensed ring aromatic hydrocarbon, a totally condensed ring aromatic hydrocarbon is preferable. In the invention, the polycyclic aromatic hydrocarbon and the condensed ring aromatic hydrocarbon means a polycyclic aromatic compound defined as follows.

More specifically, the “polycyclic aromatic hydrocarbon” means a hydrocarbon compound containing two or more aromatic rings which are constituted of carbon and hydrogen and which are mutually bonded by a carbon-carbon single bond. Specific examples include biphenyl and terphenyl.

Also the “condensed ring aromatic hydrocarbon” means a hydrocarbon compound containing two or more aromatic rings which are constituted of carbon and hydrogen and which own in common a pair of mutually adjacent and mutually bonded carbon atoms. Specific examples include naphthalene, anthracene, phenanthrene and fluorene.

Also in the formula (II), an aromatic heterocycle selected as one of the structures represented by Ar means an aromatic ring containing an element other than carbon and hydrogen. A number (Nr) of atoms constituting such cyclic structure is preferably Nr=5 and/or 6.

Kind and number of the ring-constituting element other than C (hetero element) are not particularly restricted, but S, N, O and the like are preferably used, and the ring structure may contain hetero atoms of two or more kinds and two or more in number. In particular, a heterocycle having a 5-membered structure is preferably thiophene, thiophine, furan, a heterocycle obtained by substituting a carbon atom in 3- or 4-position thereof with a nitrogen atom, pyrrole, or a heterocycle obtained by substituting a carbon atom in 3- or 4-position thereof with a nitrogen atom, and a heterocycle having a 6-membered structure is preferably pyridine.

Also in the formula (II), an aromatic group including an aromatic heterocycle selected as one of the structures represented by Ar means a bonding group containing at least an aforementioned aromatic heterocycle in an atomic group constituting the skeleton. Such group may be entirely constituted of a conjugate system or may be partially constituted of a non-conjugate system, but it is preferably entirely constituted of a conjugate system in consideration of the charge transporting ability and the light emitting property.

A substituent on the benzene ring, the polycyclic aromatic hydrocarbon, the condensed ring aromatic hydrocarbon or the heterocycle, selected as the structure represented by Ar, can be for example a hydrogen atom, an alkyl group, an alkoxy group, a phenoxy group, an aryl group, an aralkyl group, a substituted amino group, or a halogen atom. The alkyl group preferably has 1 to 10 carbon atoms, such as a methyl group, an ethyl group, a propyl group or an isopropyl group.

The alkoxy group preferably has 1 to 10 carbon atoms, such as a methoxy group, an ethoxy group, a propoxy group or an isopropoxy group.

The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted amino group can be an alkyl group, an aryl group or an aralkyl group, of which specific examples are same as described above.

In the formula (II), X represents a substituted or non-substituted divalent 1,3-phenylene group. Specifically, X is preferably the divalent 1,3-phenylene group selected from structural formulae represented by (III-1), (III-2) and (III-3).

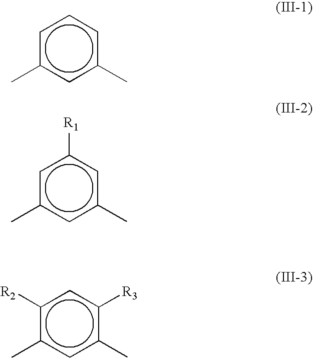

In the formulae (III-1), (III-2), and (III-3), R₁, R₂, and R₃ respectively represent a hydrogen atom, an alkyl group, a substituted or non-substituted aryl group, or a substituted or non-substituted aralkyl group.

The alkyl group preferably has 1 to 10 carbon atoms, such as a methyl group, an ethyl group, a propyl group or an isopropyl group. The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted aryl group or the substituted aralkyl group can be a hydrogen atom, an alkyl group, an alkoxy group, a substituted amino group or a halogen atom.

In the formula (II), T represents a divalent linear hydrocarbon group having 1 to 6 carbon atoms or a branched hydrocarbon group having 2 to 10 carbon atoms; and k and m represent an integer of 0 or 1, respectively. Specific structures of the T in the formula (II) are shown in below.

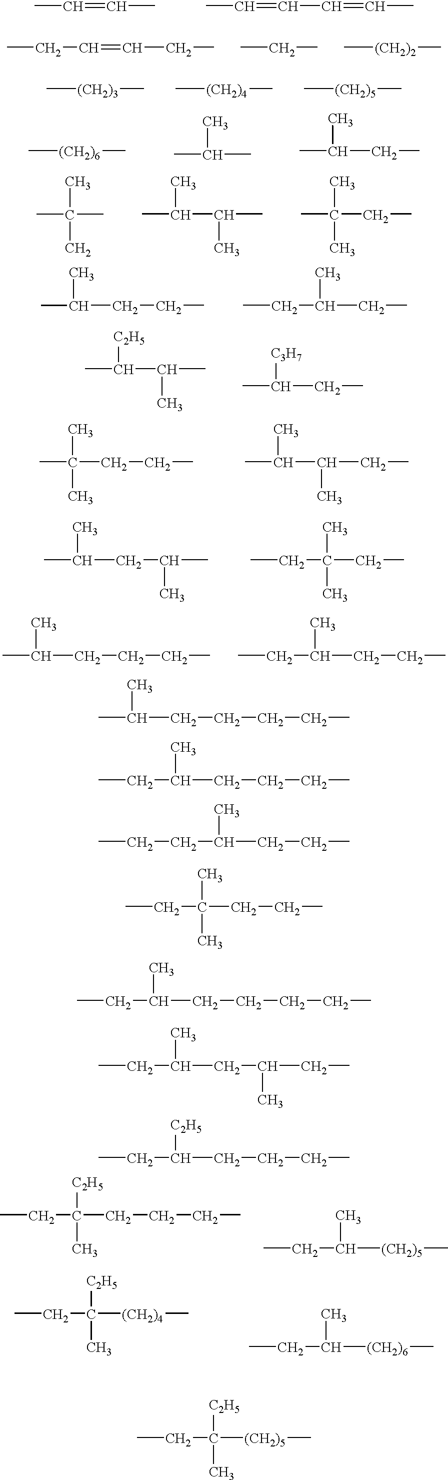

In the formulae (I-1) and (I-2), R represents a hydrogen atom, an alkyl group, a substituted or non-substituted aryl group, or a substituted or non-substituted aralkyl group.

The alkyl group preferably has 1 to 10 carbon atoms, such as a methyl group, an ethyl group, a propyl group or an isopropyl group. The aryl group preferably has 6 to 20 carbon atoms, such as a phenyl group, or a toluyl group. The araylkyl group preferably has 7 to 20 carbon atoms, such as a benzyl group or a phenetyl group. A substituent of the substituted aryl group or the substituted aralkyl group can be a hydrogen atom, an alkyl group, an alkoxy group, a substituted amino group or a halogen atom.

In the formulae (I-1) and (I-2), Y represents a divalent alcohol residue and Z represents a divalent carboxylic acid residue. Specific examples of Y and Z include those selected from following formulae (1) to (7). t,0110

In the formulae (1) to (7), R₁₁ and R₁₂ each independently represents a hydrogen atom, an alkyl group with 1 to 4 carbon atoms, an alkoxy group with 1 to 4 carbon atoms, a substituted or non-substituted phenyl group, a substituted or non-substituted aralkyl group, or a halogen atom; a, b, c each represents an integer of 1 to 10; d and e each represents an integer of 0, 1 or 2; f each represents an integer of 0 or 1; and V represents a group selected from following formulae (8) to (18).

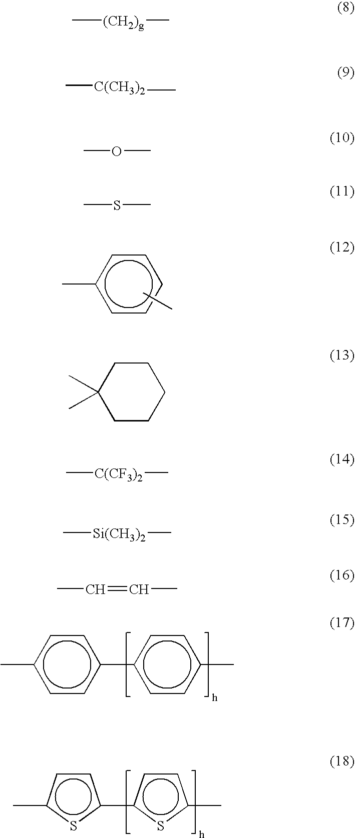

In formulae (8) to (18), g each represents an integer of 1 to 10; and h each represents an integer of 0 to 10.

In the formulae (I-1) or (I-2), p representing a degree of polymerization is within a range of 5 to 5,000, preferably 10 to 1,000 from the viewpoint of film formability and stability.

The diamine compound polymer having a 1,3-phnyline group used in the present invention preferably has a weight-average molecular weight M_{w} within a range of 5,000 to 1,000,000, more preferably 10,000 to 300,000.

While specific examples of the diamine compound polymer having the 1,3-phenylene group of the invention (Compounds 1 to 59) are shown in Tables 1 to 9, the invention is by no means restricted to these examples.

TABLE 1

| | A | | | | | |
|---|---|---|---|---|---|---|
| Compound | X | Ar | T | bond site | k | m |
| 1 | 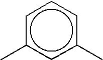 | 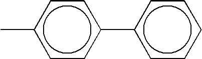 | — | 3 | 0 | 0 |
| 2 | 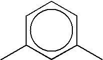 | 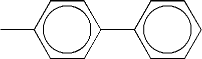 | — | 3 | 0 | 0 |
| 3 | 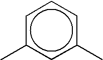 | 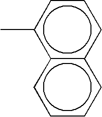 | — | 3 | 0 | 0 |
| 4 | 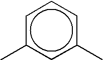 | 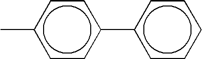 | —CH₂CH₂— | 3 | 0 | 1 |
| 5 | 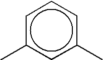 | 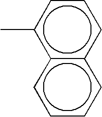 | —CH₂CH₂— | 3 | 0 | 1 |
| 6 | 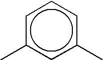 | 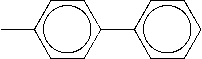 | — | 4 | 0 | 1 |
| 7 | 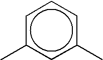 | 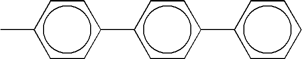 | — | 4 | 0 | 0 |
| 8 | 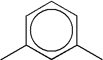 | 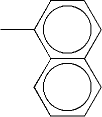 | — | 4 | 0 | 0 |

| Compound | R | Y | Z | n | p |
|---|---|---|---|---|---|
| 1 | —H | —CH₂CH₂— | — | 1 | 106 |
| 2 | —H | 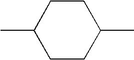 | — | 1 | 68 |
| 3 | —H | —CH₂CH₂— | — | 1 | 93 |
| 4 | —H | —CH₂CH₂— | — | 1 | 98 |
| 5 | —H | 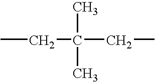 | — | 1 | 64 |
| 6 | —H | —CH₂CH₂— | — | 1 | 86 |
| 7 | —H | —CH₂CH₂— | — | 1 | 71 |
| 8 | —H | —CH₂CH₂— | — | 1 | 84 |

TABLE 2

| | A | | | | | |
|---|---|---|---|---|---|---|
| Compound | X | Ar | T | bond site | k | m |
| 9 | 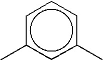 | 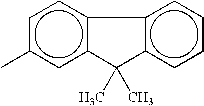 | — | 4 | 0 | 0 |
| 10 | 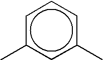 | 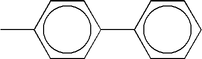 | —CH₂CH₂— | 4 | 0 | 1 |
| 11 | 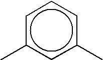 | 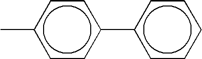 | —CH₂CH₂— | 4 | 0 | 1 |
| 12 | 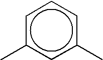 | 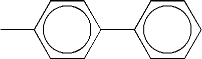 | 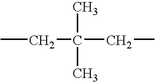 | 4 | 0 | 1 |
| 13 | 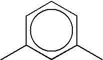 | 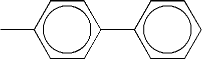 | —CH₂CH₂— | 4 | 0 | 1 |
| 14 | 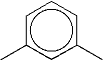 | 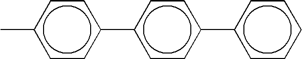 | —CH₂CH₂— | 4 | 0 | 1 |
| 15 | 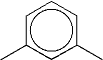 | 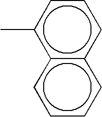 | —CH₂CH₂— | 4 | 0 | 1 |
| 16 | 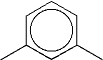 | 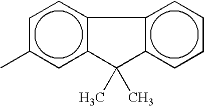 | —CH₂CH₂— | 4 | 0 | 1 |
| 17 | 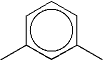 | 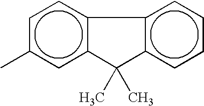 | —CH₂CH₂— | 4 | 0 | 1 |
| 18 | 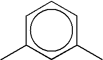 | 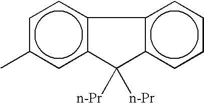 | —CH₂CH₂— | 4 | 0 | 1 |

| Compound | R | Y | Z | n | p |
|---|---|---|---|---|---|
| 9 | —H | —CH₂CH₂— | — | 1 | 79 |
| 10 | —H | —CH₂CH₂— | — | 1 | 160 |
| 11 | —CH₃ | —CH₂CH₂— | — | 1 | 160 |
| 12 | —H | —CH₂CH₂— | — | 1 | 83 |
| 13 | —H | 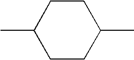 | — | 1 | 85 |
| 14 | —H | —CH₂CH₂— | | 1 | 63 |
| 15 | —H | —CH₂CH₂— | — | 1 | 77 |
| 16 | —H | —CH₂CH₂— | — | 1 | 105 |
| 17 | —CH₃ | —CH₂CH₂— | — | 1 | 105 |
| 18 | —H | —CH₂CH₂— | — | 1 | 86 |

TABLE 3

| | A | | | | | |
|---|---|---|---|---|---|---|
| Compound | X | Ar | T | bond site | k | m |
| 19 | 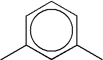 | 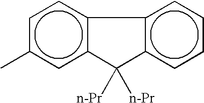 | —CH₂CH₂— | 4 | 0 | 1 |
| 20 | 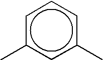 | 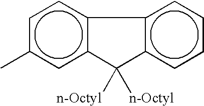 | —CH₂CH₂— | 4 | 0 | 1 |
| 21 | 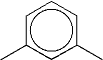 | 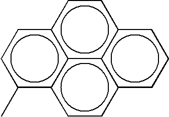 | —CH₂CH₂— | 4 | 0 | 1 |
| 22 | 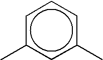 | 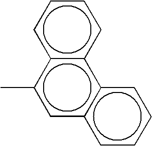 | —CH₂CH₂— | 4 | 0 | 1 |
| 23 | 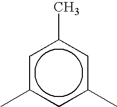 | 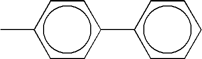 | —CH₂CH₂— | 4 | 0 | 1 |
| 24 | 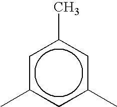 | 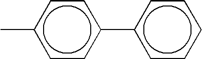 | —CH₂CH₂— | 4 | 0 | 1 |
| 25 | 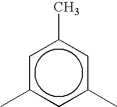 | 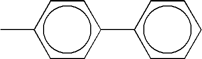 | 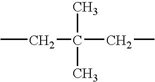 | 4 | 0 | 1 |

| Compound | R | Y | Z | n | p |
|---|---|---|---|---|---|
| 19 | —H | 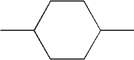 | — | 1 | 86 |
| 20 | —H | —CH₂CH₂— | — | 1 | 92 |
| 21 | —H | —CH₂CH₂— | — | 1 | 45 |
| 22 | —H | —CH₂CH₂— | — | 1 | 73 |
| 23 | —H | —CH₂CH₂— | — | 1 | 160 |
| 24 | —CH₃ | —CH₂CH₂— | — | 1 | 155 |
| 25 | —H | —CH₂CH₂— | — | 1 | 81 |

TABLE 4

| | A | | | | | |
|---|---|---|---|---|---|---|
| Compound | X | Ar | T | bond site | k | m |
| 26 | 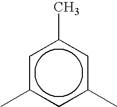 | 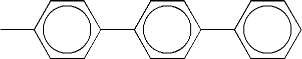 | —CH₂CH₂— | 4 | 0 | 1 |
| 27 | 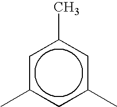 | 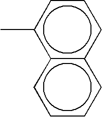 | —CH₂CH₂— | 4 | 0 | 1 |
| 28 | 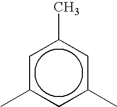 | 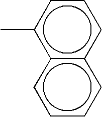 | —CH₂CH₂— | 4 | 0 | 1 |
| 29 | 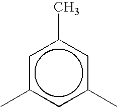 | 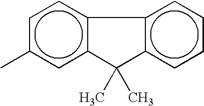 | —CH₂CH₂— | 4 | 0 | 1 |
| 30 | 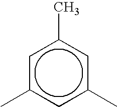 | 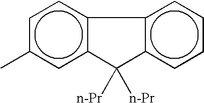 | —CH₂CH₂— | 4 | 0 | 1 |
| 31 | 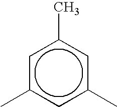 | 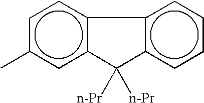 | —CH₂CH₂— | 4 | 0 | 1 |
| 32 | 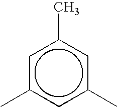 | 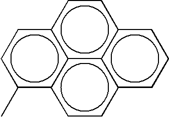 | —CH₂CH₂— | 4 | 0 | 1 |

| Compound | R | Y | Z | n | p |
|---|---|---|---|---|---|
| 26 | —H | —CH₂CH₂— | — | 1 | 120 |
| 27 | —H | —CH₂CH₂— | — | 1 | 79 |
| 28 | —H | —(CH₂)₄— | — | 1 | 73 |
| 29 | —H | —CH₂CH₂— | — | 1 | 92 |
| 30 | —H | —CH₂CH₂— | — | 1 | 86 |
| 31 | —H | 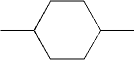 | — | 1 | 86 |
| 32 | —H | —CH₂CH₂— | — | 1 | 89 |

TABLE 5

| | A | | | | | |
|---|---|---|---|---|---|---|
| Compound | X | Ar | T | bond site | k | m |
| 33 | 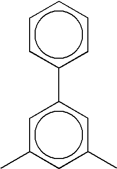 | 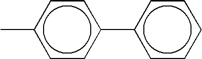 | —CH₂CH₂— | 4 | 0 | 1 |
| 34 | 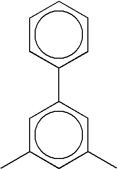 | 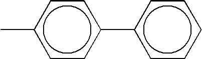 | 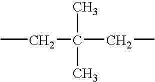 | 4 | 0 | 1 |
| 35 | 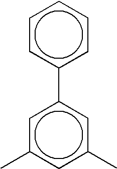 | 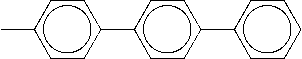 | —CH₂CH₂— | 4 | 0 | 1 |
| 36 | 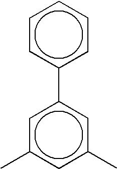 | 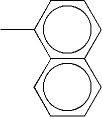 | —CH₂CH₂— | 4 | 0 | 1 |
| 37 | 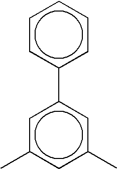 | 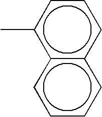 | —CH₂CH₂— | 4 | 0 | 1 |

| Compound | R | Y | Z | n | p |
|---|---|---|---|---|---|
| 33 | —H | —CH₂CH₂— | — | 1 | 101 |
| 34 | —H | —CH₂CH₂— | — | 1 | 91 |
| 35 | —H | —CH₂CH₂— | — | 1 | 96 |
| 36 | —H | —CH₂CH₂— | — | 1 | 99 |
| 37 | —H | —(CH₂)₄— | — | 1 | 73 |

TABLE 6

| | A | | | | | | | | | | |
|---|---|---|---|---|---|---|---|---|---|---|---|
| Com- | | | | bond | | | | | | | |
| pound | X | Ar | T | site | k | m | R | Y | Z | n | p |
| 38 | 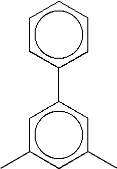 | 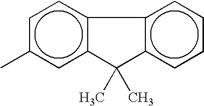 | —CH₂CH₂— | 4 | 0 | 1 | —H | —CH₂CH₂— | — | 1 | 81 |
| 39 | 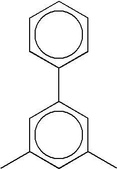 | 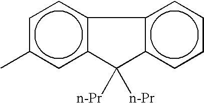 | —CH₂CH₂— | 4 | 0 | 1 | —H | —CH₂CH₂— | — | 1 | 84 |
| 40 | 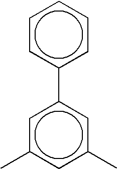 | 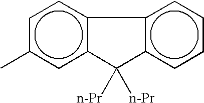 | —CH₂CH₂— | 4 | 0 | 1 | —H | 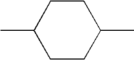 | | 1 | 68 |
| 41 | 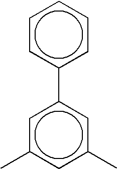 | 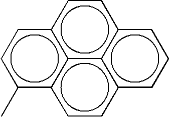 | —CH₂CH₂— | 4 | 0 | 1 | —H | —CH₂CH₂— | — | 1 | 58 |
| 42 | 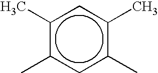 | 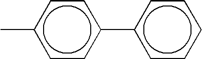 | —CH₂CH₂— | 4 | 0 | 1 | —H | —CH₂CH₂— | — | 1 | 101 |

TABLE 7

| | A | | | | | |
|---|---|---|---|---|---|---|
| Compound | X | Ar | T | bond site | k | m |
| 43 | 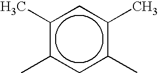 | 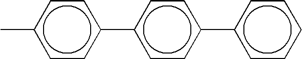 | —CH₂CH₂— | 4 | 0 | 1 |
| 44 | 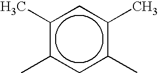 | 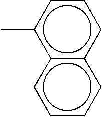 | —CH₂CH₂— | 4 | 0 | 1 |
| 45 | 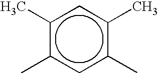 | 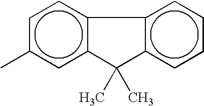 | —CH₂CH₂— | 4 | 0 | 1 |
| 46 | 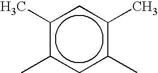 | 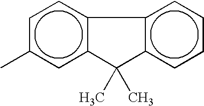 | —CH₂CH₂— | 4 | 0 | 1 |
| 47 | 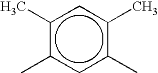 | 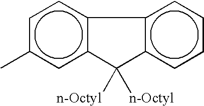 | —CH₂CH₂— | 4 | 0 | 1 |
| 48 | 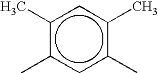 | 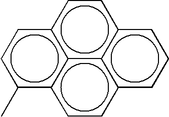 | —CH₂CH₂— | 4 | 0 | 1 |

| Compound | R | Y | Z | n | p |
|---|---|---|---|---|---|
| 43 | —CH₃ | —CH₂CH₂— | — | 1 | 96 |
| 44 | —H | —CH₂CH₂— | — | 1 | 82 |
| 45 | —H | —(CH₂)₄— | — | 1 | 92 |
| 46 | —H | 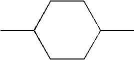 | — | 1 | 74 |
| 47 | —H | —CH₂CH₂— | — | 1 | 83 |
| 48 | —H | —CH₂CH₂— | — | 1 | 49 |

TABLE 8

| | A | | | | | |
|---|---|---|---|---|---|---|
| Compound | X | Ar | T | bond site | k | m |
| 49 | 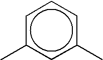 | 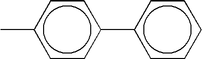 | —CH₂CH₂— | 3 | 0 | 1 |
| 50 | 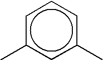 | 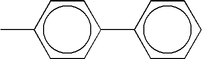 | —CH₂CH₂— | 3 | 0 | 1 |
| 51 | 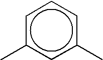 | 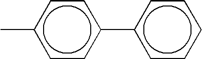 | 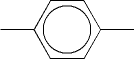 | 3 | 0 | 1 |
| 52 | 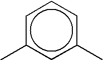 | 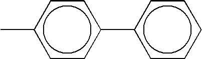 | —CH₂CH₂— | 4 | 0 | 1 |
| 53 | 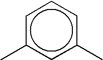 | 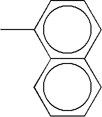 | —CH₂CH₂— | 4 | 0 | 1 |
| 54 | 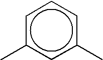 | 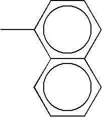 | —CH₂CH₂— | 4 | 0 | 1 |
| 55 | 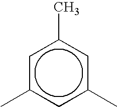 | 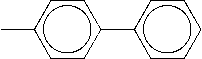 | —CH₂CH₂— | 4 | 0 | 1 |
| 56 | 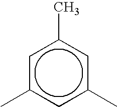 | 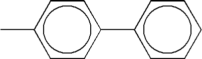 | —CH₂CH₂— | 4 | 0 | 1 |

| Compound | B,B′ | Y | Z | n | p |
|---|---|---|---|---|---|
| 49 | —O—Y—O—H | —CH₂CH₂— | —CH₂CH₂— | 1 | 90 |
| 50 | —O—Y—O—H | —CH₂CH₂— | 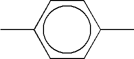 | 1 | 86 |
| 51 | —O—Y—O—H | —CH₂CH₂— | 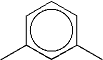 | 1 | 73 |
| 52 | —O—Y—O—H | —CH₂CH₂— | 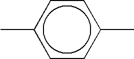 | 1 | 86 |
| 53 | —O—Y—O—H | 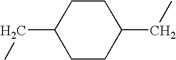 | 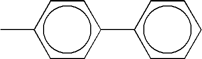 | 1 | 72 |
| 54 | —O—Y—O—H | —CH₂CH₂— | 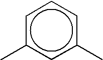 | 1 | 95 |
| 55 | —O—Y—O—H | —CH₂CH₂— | 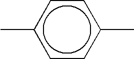 | 1 | 87 |
| 56 | —O—Y—O—H | 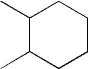 | 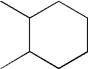 | 1 | 81 |

TABLE 9

| | A | | | | | |
|---|---|---|---|---|---|---|
| Compound | X | Ar | T | bond site | k | m |
| 57 | 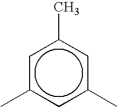 | 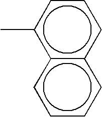 | —CH₂CH₂— | 4 | 0 | 1 |
| 58 | 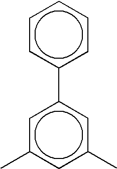 | 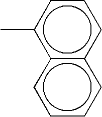 | —CH₂CH₂— | 4 | 0 | 1 |
| 59 | 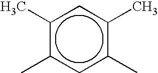 | 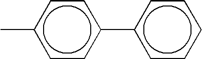 | —CH₂CH₂— | 4 | 0 | 1 |

| Compound | B,B′ | Y | Z | n | p |
|---|---|---|---|---|---|
| 57 | —CH₂CH₂— | —CH₂CH₂— | 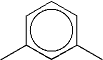 | 1 | 102 |
| 58 | —CH₂CH₂— | —CH₂CH₂— | 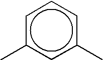 | 1 | 75 |
| 59 | —CH₂CH₂— | —CH₂CH₂— | 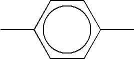 | 1 | 98 |

In Tables 1 to 9, compounds 1 to 48 in Tables 1 to 7 are specific examples of the compounds represented by the formula (I-1), and compounds 49 to 59 in Tables 8 and 9 are specific examples of the compounds represented by the formula (I-2).

The methods for synthesizing the polymers of the invention will be described in detail below. However, the synthetic method of the invention is not restricted to those methods.

The method for synthesizing the monomer to be a starting material of a polymer comprises, for example, firstly synthesizing a diarylamine by allowing an arylamine to react with a halogenated carboalkoxyalkylbenzene or halogenated carboalkoxybenzene, followed by allowing the diarylamine to react with bishalogenated benzidine; or allowing an arylamine or diarylbenzene to react with halogenated carboalkoxyalkylbenzene or halogenated carboalkoxybenzene.

JP-A No. 5-80550 discloses a method for synthesizing a charge transport material having an alkylenecarboxylic acid ester group comprising the steps of forming a Grignard reagent with Mg after introducing a chloromethyl group, and esterifying the product after converting it into a carboxylic acid with carbon dioxide.

However, the chloromethyl group cannot be introduced into the starting material at an early stage of the reaction since the chloromethyl group is highly reactive. Accordingly, the methyl group introduced into the starting material at the early stage of the reaction is converted into a chloromethyl group after forming a triarylamine skeleton or tetraarylbenzidine skeleton; or a non-substituted material is used as a starting material, and a functional group such as a formyl group introduced by a substitution reaction of an aromatic ring is reduced to an alcohol after forming a tetraarylbenzidine skeleton, followed by converting into a chloromethyl group using a halogenating reagent such as thionyl chloride, or directly converting into the chloromethyl group using paraformaldehyde, hydrochloric acid and the like.

However, since the charge transport material having a triarylamine skeleton or a tetraarylbenzidine skeleton is highly reactive, the halogen is readily substituted to the aromatic ring when the introduced methyl group is converted into the chloromethyl group. Therefore, it is practically impossible to selectively chlorinate only the methyl group.

The chloromethyl group can be introduced only to a para-position relative to the nitrogen atom by the method for converting into the chloromethyl group after introducing the functional group such as the formyl group, or by a direct chloromethylation method, using a non-substituted material as a starting material. Accordingly, the alkylenecarboxylic acid ester group can be only introduced into the para-position. The method for converting into the chloromethyl group after introducing the formyl group requires a long reaction time.

On the other hand, the method for obtaining monomers by allowing arylamine or diarylbenzidine to react with halogenated carboalkoxyalkylbenzene is excellent in changing the position of the substituent for readily controlling ionization potential. This method enables the properties of the diamine compound polymer having 1,3-phenylene groups to be controlled. Since the monomer used for synthesizing the diamine compound polymer having 1,3-phenylene groups of the invention is able to readily accept various substituents at arbitrary positions while it is chemically stable, the monomer can be readily handled to enable the problems above to be solved.

The monomers used for synthesizing the diamine compound polymer are obtained as the structure represented by following formula (IV), and can be synthesized by polymerizing the monomer by the method known in the art as described in Jikken Kagaku Koza (Handbook of Experimental Chemistry), 4th edition, Vol. 28.

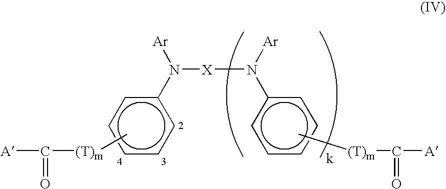

In formula (IV), A′ represents a hydroxyl group, a halogen atom or an alkoxy group [—OR₃ (where R₁₃ represents an alkyl group (such as a methyl group, an ethyl group)]; and Ar, X, T, k and m are the same as those described in the formula (II).

(1) Case of A′ is a hydroxyl group

Divalent alcohols represented by HO—(Y—O)ₙ—H (Y and n are the same as Y in the formula (I-1) and the same is true both in the formulae (2) and (3) below) are mixed in an approximately equal equivalent to the monomer, and are polymerized using an acid catalyst. The acid catalyst available include sulfuric acid, toluenesufonic acid and trifluoroacetic acid that can be used for usual esterification reactions. The acid catalyst is used in a range of 1/10000to 1/10 part by weight, preferably 1/1000 to 1/50 part by weight, relative to 1 part by weight of the monomer. Solvents capable of azeotropic distillation together with water is preferably used for removing water formed during the synthesis, and toluene, chlorobenzene and 1-chloronaphthalene are effective. The solvent is used in a range of 1 to 100 parts by weight, preferably 2 to 50 parts by weight, relative to 1 part by weight of the monomer.

While the reaction temperature may be arbitrarily determined, it is preferable to react at the boiling point of the solvent in order to remove water formed during the polymerization. The reaction product is dissolved into a solvent capable of dissolving the reaction product after the reaction when no solvent is used. When a solvent is used, the reaction product is directly added dropwise into a poor solvent that hardly dissolves the polymer such as alcohols such as methanol and ethanol and acetone, therefore the polymer is precipitated. The polymer obtained is dried after thoroughly washing with water or organic solvents. Otherwise, re-precipitation treatments are repeated by dissolving the polymer in an appropriate organic solvent followed by adding in a poor solvent for precipitating the polymer. It is preferable to efficiently stir the solvent with a mechanical stirrer for re-precipitation during reprecipitation treatment.

The solvent for dissolving the polymer for re-precipitation is used in a range of 1 to 100 parts by weight, preferably 2 to 50 parts by weight, relative to 1 part by weight of the polymer. The poor solvent is used in a range of 1 to 1000 parts by weight, preferably in a range of 10 to 500 parts by weight, relative to 1 part by weight of the polymer.

(2) Case of A′ is a Halogen Divalent alcohols represented by HO—(Y—O)ₙ—H are mixed in an approximately equal equivalent to the monomer, and are polymerized using an organic base catalyst such as pyridine and triethylamine. The organic base catalyst is used in a range of 1 to 10 equivalent, preferably 2 to 5 equivalent, relative to 1 part by weight of the monomer.

Methylene chloride, tetrahydrofuran (THF), toluene, chlorobenzene and 1-chloronaphthalene are effective as the solvent, which is used in a range of 1 to 100 parts by weight, preferably in a range of 2 to 50 parts by weight, relative to 1 part by weight of the monomer. The reaction temperature may be arbitrarily determined. The polymer obtained is purified by re-precipitation as described above. An interface polymerization method may be used when divalent alcohols such as bisphenol having a high acidity are used. After water and an equivalent of the base are added to and dissolved in the divalent alcohol, the divalent alcohol and an equivalent of the monomer are polymerized with vigorous stirring. Water is used in a range of 1 to 1000 parts by weight, preferably 2 to 500 parts by weight, relative to 1 part by weight of the divalent alcohol.

Methylene chloride, dichloroethane, trichloroethane, toluene, chlorobenzene and 1-chloronaphthalene are effective as the solvent for dissolving the monomer. The reaction temperature may be arbitrarily determined, and a phase-transfer catalyst such as an ammonium salt and a sulfonium salt is effectively used for accelerating the reaction. The phase-transfer catalyst is used in a range of 0.1 to 10 parts by weight, preferably 0.2 to 5 parts by weight, relative to 1 part by weight of the monomer.

(3) Case of A′ is an Alkoxy Group [—OR₁₃ (where R₁₃ Represents an Alkyl Group (such as a Methyl Group, an Ethyl Group)]:

The compound is synthesized by an ester exchange reaction by the steps comprising: adding an excess amount of divalent alcohol represented by HO—(Y—O)ₙ—H; and heating the alcohol using an inorganic acid such as sulfuric acid or phosphoric acid, titanium alkoxide, calcium or cobalt acetate, calcium or cobalt carbonate or zinc oxide as a catalyst.

The divalent alcohol is used in a range of 2 to 100 equivalent, preferably 3 to 50 equivalent relative to 1 equivalent of the monomer. The catalyst is used in a range of 1/1000 to 1 part by weight, preferably 1/100 to ½ parts by weight relative to 1 equivalent of the monomer.

The reaction is performed at a reaction temperature of 200 to 300° C, and the reaction is preferably proceeded under a reduced pressure after completing an ester exchange reaction from the alkoxyl group to the —O—(Y—O—)ₙ—H group in order to accelerate the polymerization reaction by elimination of the divalent HO—(Y—O)ₙ—H group. The reaction may be proceeded by removing the divalent HO—(Y—O—)ₙ—H group by azeotropic distillation using a high boiling point solvent such as 1-chloronaphthalene capable of azeotropic distillation with the divalent HO—(Y—O—)ₙ—H group under a reduced pressure.

The polymer represented by the formulae (I-1) and (I-2) may be also synthesized as follows. The polymer can be obtained by forming the compound represented by the following formula (V) by allowing the monomer to react by adding an excess amount of the divalent alcohol in each case described above, followed by allowing the compound represented by the following formula (V) as a monomer to react with a divalent carboxylic acid or divalent carboxylic acid halide by the same method as described in above (2).

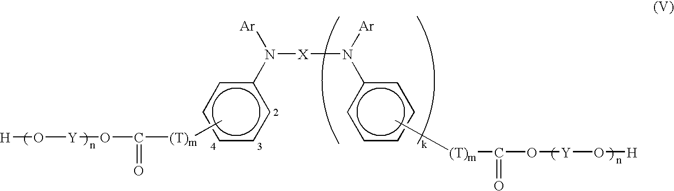

Y and n in the formula (V) are the same as Y and n in the formulae (I-1) and (I-2) above, and Ar, X, T, k and m, are the same as Ar, X, T, k and m in the formula (II).

Synthesis of the diamine compound polymer having 1,3-phenylene groups of the invention is easy with a high reaction yield. The polymer of the invention can be synthesized by taking advantage of the synthesis methods as described above with a controlled molecular structure and molecular weight.

While the properties of the diamine compound polymer having 1,3-phenylene groups of the invention are not uniquely defined, the properties may be readily controlled within a desired range such as a mobility of 10⁻⁷ to 10⁻⁴ cm² /Vs, a quantum efficiency of about 0.1 to 0.5, and a glass transition temperature of 75 to 200° C. by controlling the molecular structure and molecular weight in the synthesis.

While it may be required for manufacturing an organic electronic device to use the diamine compound polymer having 1,3-phenylene groups of the invention by dissolving in a solvent or by mixing with other materials such as resins, the polymer may be synthesized by controlling the molecular structure and molecular weight considering solubility in the solvent or compatibility with the resin. Accordingly, the diamine compound polymer having 1,3-phenylene groups of the invention can be utilized as a solution dissolved in a solvent together with other resin materials, if necessary, for manufacturing the organic electronic device, and the production cost may be reduced by using a liquid phase film forming method. Heat resistance can be made to be readily compatible with chemical stability by controlling the molecular structure.

When the diamine compound polymer having the 1,3-phenylne group is applied to various electronic devices, basic properties required for the charge transfer material (charge mobility, matching of oxidation potential, quantum efficiency, film deposition ability and durability) may be readily optimized depending on the application field. Since the charge transfer material of the invention allows the charge mobility and quantum efficiency to be selected higher levels as compared with conventional charge transfer materials, high performance organic electronic devices may be produced. In addition, since the diamine compound polymer having the 1,3-phenylene group of the invention has a higher glass transition temperature than that of the charge transfer material of the conventional low molecular weight type, and is excellent in thermal stability, the charge transfer material of the invention can be used for organic electroluminescence elements that is required to have heat stability.

Some embodiments of the invention are outlined below.

According to an aspect of the invention, diamine compound polymers having a 1,3-phenylene group selected from structural formulae represented by formulae (I-1) and (I-2) is provided.

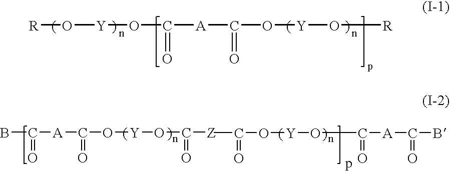

Where, in the formulae (I-1) and (I-2), A represents a structure represented by the following formula (II); R represents a hydrogen atom, an alkyl group, a substituted or non-substituted aryl group, or a substituted or non-substituted aralkyl group; Y represents a divalent alcoholic residue; Z represents a divalent carboxylic acid residue; B and B′ independently represent —O—(Y—O)ₙ—R or —O—(Y—O)ₙ—CO—Z—CO—OR′ (where R, Y and Z have the same meanings as described above, and R′ represents an alkyl group, a substituted or non-substituted aryl group, or a substituted or non-substituted aralkyl group); n represents an integer of 1 to 5; and p represents an integer of 5 to 5000;

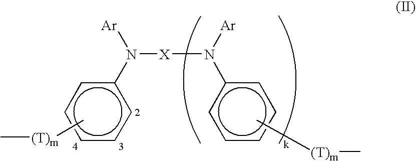

Where, in the formula (II), Ar represents a substituted or non-substituted aromatic group; X represents a substituted or non-substituted divalent phenylene group; T represents a divalent linear hydrocarbon group having 1 to 6 carbon atoms or a branched hydrocarbon group having 2 to 10 carbon atoms; and k and m represent an integer of 0 or 1, respectively.

In the formula (II), X may be a divalent 1,3-phenylene group selected from structural formulae represented by following structural formulae (III-1), (III-2) or (III-3):

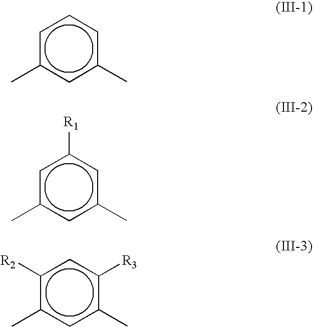

In the formulae (III-2) and (III-3), R₁, R₂ and R₃ each independently represent a hydrogen atom, an alkyl group, a substituted or non-substituted aryl group, or a substituted or non-substituted aralkyl group.

Further, In the formula (II), Ar may be a substituted or non-substituted phenyl group, a substituted or non-substituted monovalent polynuclear aromatic hydrocarbon having 2 to 10 aromatic groups, a substituted or non-substituted monovalent condensed ring aromatic compound having 2 to 10 aromatic groups, a substituted or non-substituted monovalent aromatic heterocyclic ring, or a substituted or non-substituted monovalent aromatic group containing at least one aromatic heterocyclic ring.

In the formula (II), a number of the aromatic rings constituting the polycyclic aromatic hydrocarbon or the condensed ring aromatic hydrocarbon may be 2 to 5.

In the formula (II), the condensed ring aromatic hydrocarbon of Ar may be a totally condensed ring aromatic hydrocarbon,

In the formula (II), the polycyclic aromatic hydrocarbon of Ar may be a biphenyl or a terphenyl.

In the formula (II), the condensed ring aromatic hydrocarbon of Ar may be a naphthalene, an anthracene, a phenanthrene or a fluorene.

### EXAMPLES

The invention is described hereinafter with reference to examples. Firstly, monomers for the charge transfer material as used starting materials are obtained as follow.

### Synthesis Example 1

### Synthesis of N,N′-bis[(4-phenyl)phenyl]-N,N′-bis[4-(2-methoxycarbonylethyl)phenyl]-1,3-phenylenediamine[Compound (VI-1) represented by the Formula Below]

36.5 g (0.11 mol) of N-bis[(4-phenyl)phenyl]-N-bis[4-(2-methoxycarbonylethyl)phenyl]amine, 16.5 g (0.05 mol) of 1,3-diiodobenzene, 13.8 g (0.1 mol) of potassium carbonate, 1.25 g (0.005 mol) of copper sulfate pentahydrate and 100 ml of o-dichlorobenzene are added into a 500 ml three-neck flask, and the mixture is stirred at 180° C. for 20 hours in a nitrogen stream. After the reaction, the solution is cooled to room temperature, the reaction product is dissolved in 400 ml of toluene, and insoluble products are filtered through cerite. The filtrate is concentrated, and is subjected to purification by silica gel column chromatography using a mixed solvent of toluene and ethyl acetate as an elution solvent to obtain N,N′-bis[(4-phenyl)phenyl]-N,N′-bis[4-(2-methoxycarbonylethyl)phenyl]-1,3-phenylenediamine.

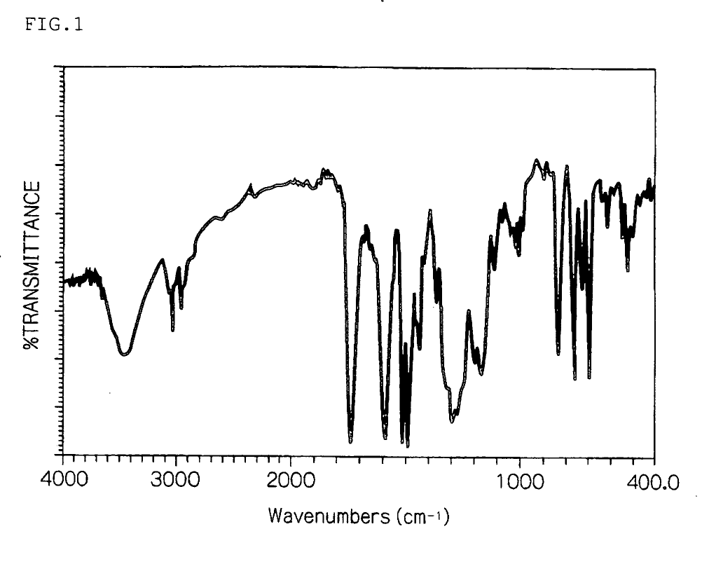

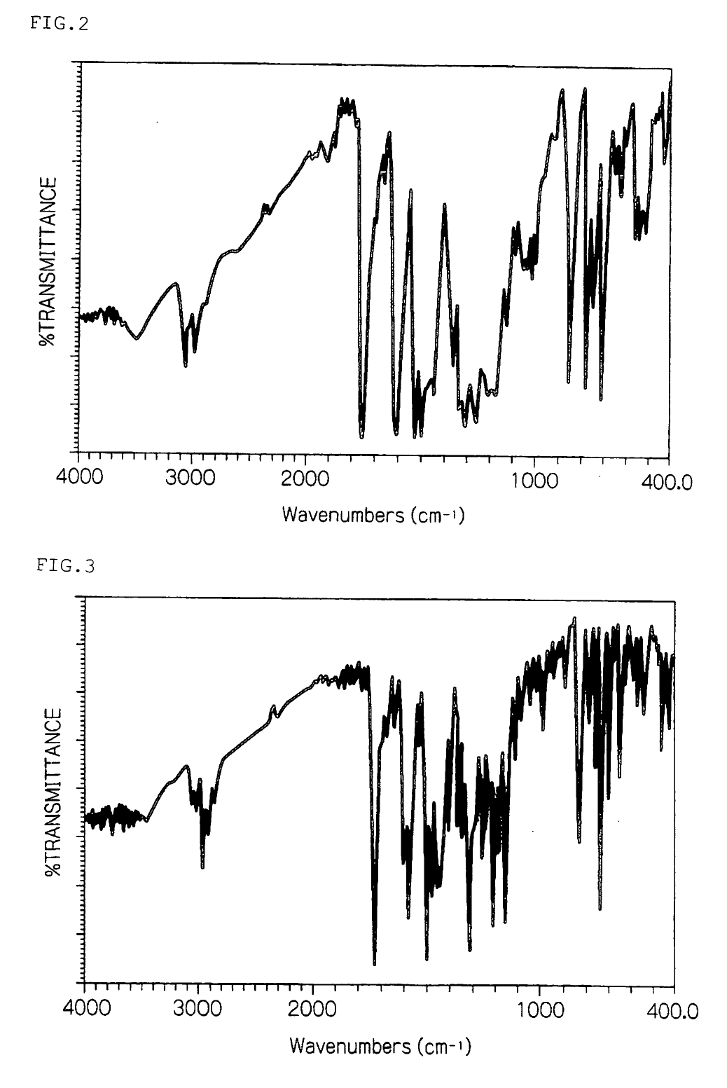

The melting point of this compound is 128 to 129° C. An IR spectrum of this compound is shown in FIG. 1. In FIG. 1, the vertical axis shows the wavelength, and the horizontal axis shows the transmittance. These are the same as in other IR spectra shown below (FIGS. 2 to 8).

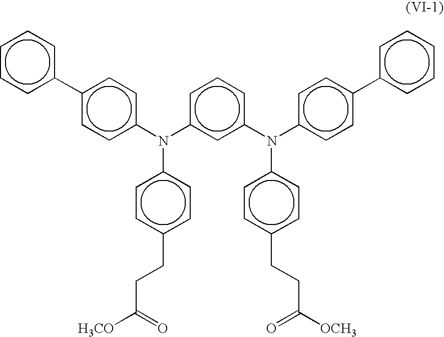

### Synthesis Example 2

### Synthesis of N,N′-bis[(4-phenyl)phenyl]-N,N′-bis[4-(2-methoxycarbonylethyl)phenyl]-5-methyl-1,3-phenylenediamine [Compound (VI-2) Represented by the Formula Below]

36.5 g (0.11 mol) of N-bis[(4-phenyl)phenyl]-N-bis[4-(2-methoxycarbonylethyl)phenyl]amine, 12.5 g (0.05 mol) of 3,5-dibromotoluene, 13.8 g (0.1 mol) of potassium carbonate, 1.25 g (0.005 mol) of copper sulfate pentahydrate and 100 ml of n-tridecane are added into a 500 ml three-neck flask, and the mixture is stirred at 230° C. for 25 hours in a nitrogen stream. After the reaction, the solution is cooled to room temperature, the reaction product is dissolved in 400 ml of toluene, and insoluble products are filtered through cerite. The filtrate is concentrated, and is subjected to purification by silica gel column chromatography using a mixed solvent of toluene and ethyl acetate as an elution solvent to obtain N,N′-bis[(4-phenyl)phenyl]-N,N′-bis[4-(2-methoxycarbonylethyl)phenyl]-5-methyl-1,3-phenylenediamine. The IR spectrum of this compound is shown in FIG. 2.

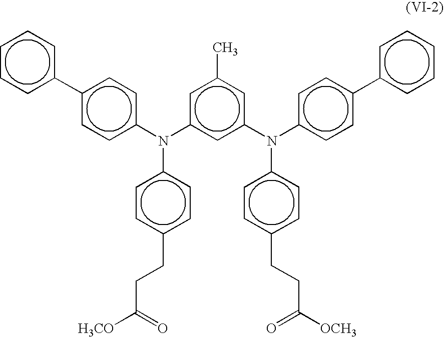

### Synthesis Example 3

### Synthesis of N,N′-di[(2-fluolenyl)-N,N′-bis[4-(2-methoxycarbonylethyl)phenyl]-1,3-phenylenediamine[Compound (VI-3) Represented by the Formula Below]

40.9 g (0.11 mol) of N-di(2-fluorenyl)-N-bis[4-(2-methoxycarbonylethyl)phenyl]amine, 16.5 g (0.05 mol) of 1,3-diiodobenzene, 13.8 g (0.1 mol) of potassium carbonate, 1.25 g (0.005 mol) of copper sulfate pentahydrate and 100 ml of n-tridecane are added into a 500 ml three-neck flask, and the mixture is stirred at 230° C. for 10 hours in a nitrogen stream. After the reaction, the solution is cooled to room temperature, the reaction product is dissolved in 400 ml of toluene, and insoluble products are filtered through cerite. The filtrate is concentrated, and is subjected to purification by silica gel column chromatography using toluene as an elution solvent to obtain N,N′-di[(2-fluolenyl)-N,N′-bis[4-(2-methoxycarbonyl-ethyl)phenyl]-1,3-phenylenediamine. The melting point of this compound is 181 to 182° C. The IR spectrum of this compound is shown in FIG. 3.

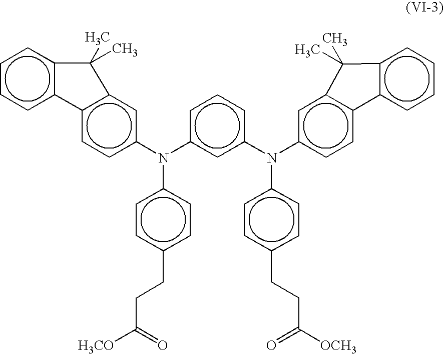

### Synthesis Example 4

### Synthesis of N,N′-di[(1-pyrenyl)-N,N′-bis[4-(2-methoxycarbonylethyl)phenyl]-1,3-phenylenediamine[Compound (VI-4) Represented by the Formula Below]

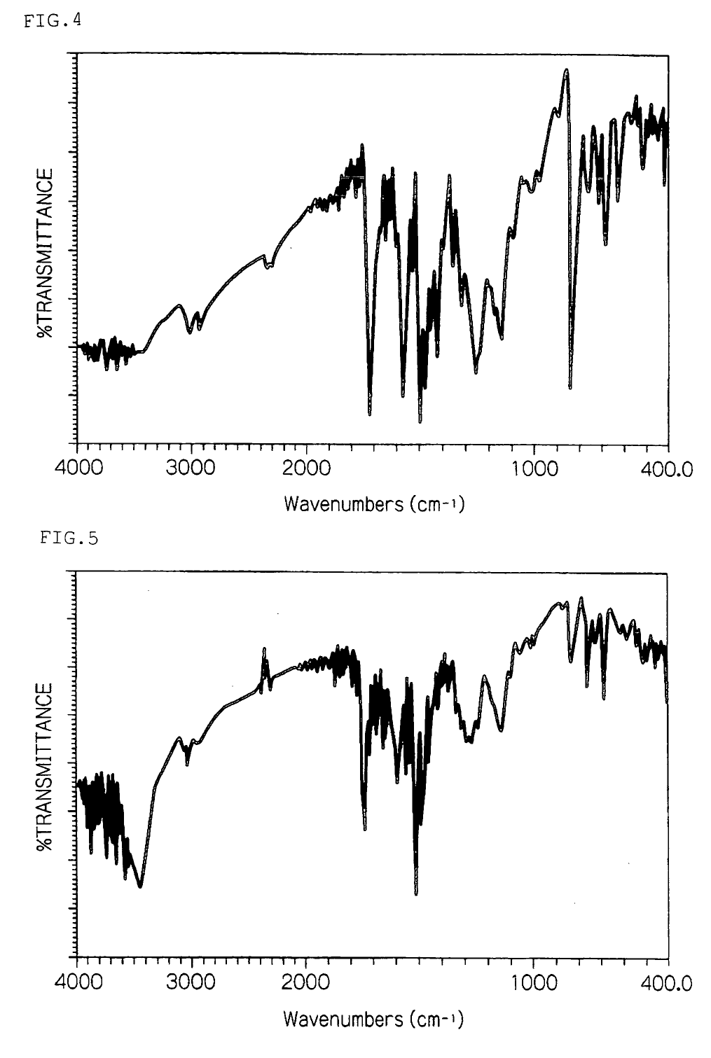

41.7 g (0.11 mol) of N-di(1-pyrenyl)-N-bis[4-(2-methoxycarbonylethyl)-phenyl]amine, 16.5 g (0.05 mol) of 1,3-diiodobenzene, 13.8 g (0.1 mol) of potassium carbonate, 1.25 g (0.005 mol) of copper sulfate pentahydrate and 100 ml of n-tridecane are added into a 500 ml three-neck flask, and the mixture is stirred at 230° C. for 14 hours in a nitrogen stream. After the reaction, the solution is cooled to room temperature, the reaction product is dissolved in 400 ml of toluene, and insoluble products are filtered through cerite. The filtrate is concentrated, and is subjected to purification by silica gel column chromatography using a mixed solvent of toluene and ethyl acetate as an elution solvent to obtain N,N′-di[(1-pyrenyl)-N,N′-bis[4-(2-methoxycarbonylethyl)phenyl]-1,3-phenylenediamine. The melting point of this compound is 110° C. The IR spectrum of this compound is shown in FIG. 4.

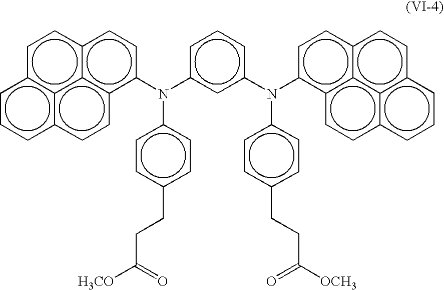

A polymer (a diamine compound polymer having the 1,3-phenylene group) is synthesized as follows using the charge transfer monomer obtained by the method as described above.

### Example 1

### Synthesis of Polymer[Compound (10)]

1.0 g of N,N′-bis[(4-pnenyl)phenyl]-N,N′-bis[4-(2-methoxycarbonyl-ethyl)phenyl]-1,3-phenylenediamine, 5 ml of ethyleneglycol and 0.02 g of tetrabutoxy titanium are added into a 50 ml three-neck flask, and the mixture is stirred by heating at 200° C. for 5 hours in a nitrogen stream. After confirming that the N,N′-bis[(4-pnenyl)phenyl]-N,N′-bis[4-(2-methoxycarbonyl-ethyl)phenyl]-1,3-phenylenediamine has been used up, the reaction solution is heated at 210° C. while ethyleneglycol is removed by distillation under a reduced pressure of 50 Pa, and the reaction is continued for 4 hours.

The reaction solution is cooled to room temperature thereafter, and 200 ml of tetrahydrofuran (THF) is added to dissolve the product. Impurities are filtered off with a polytetrafluoroethylene (PTFE) filter with a pore size of 0.5 μm. The filtrate is added dropwise into 500 ml of methanol with stirring to precipitate the polymer. The polymer obtained is filtered off, thoroughly washed with methanol and dried to obtain 1.0 g of polymer (10). The weight average molecular weight (Mw) is found to be 1.2×10⁵ (as converted into styrene) from the measurement by GPC, and the degree of polymerization (p) is about 160 as determined from the molecular weight of the monomer. The IR spectrum of this compound is shown in FIG. 5.

### Example 2

### Synthesis of Polymer[Compound (23)]

1.0 g of N,N′-bis[(4-phenyl)phenyl]-N,N′-bis[4-(2-methoxycarbonylethyl)-phenyl]-5-methyl-1,3-phenylenediamin e, 5 ml of ethyleneglycol and 0.02 g of tetrabutoxy titanium are added into a 50 ml three-neck flask, and the mixture is stirred by heating at 200° C. for 5 hours in a nitrogen stream. After confirming that the N,N′-bis[4-(2-methoxycarbonylethyl)phenyl]-5-methyl-1,3-phenylenediamine has been used up, the reaction solution is heated at 210° C. while ethyleneglycol is removed by distillation under a reduced pressure of 50 Pa, and the reaction is continued for 4 hours.

The reaction solution is cooled to room temperature thereafter, and the reaction product is dissolved in 200 ml of tetrahydrofuran (THF). Insoluble products are filtered off using a polytetraethylene (PTFE) filter with a pore diameter of 0.5 μm, and the filtrate is added dropwise in 500 ml of methanol with stirring to precipitate the polymer. The polymer is isolated by filtration and thoroughly washed with methanol to obtain 1.0 g of polymer (23) after drying. The molecular weight (Mw) is found to be 1.2×10⁵ (as converted into styrene) from the measurement by GPC, and the degree of polymerization (p) is as determined from the molecular weight is approximately 160. The IR spectrum of this compound is shown in FIG. 6.

### Example 3

### Synthesis of Polymer[Compound (16)]

1.0 g of N,N′-di(2-fruolenyl)-N,N′-bis[4-(2-methoxycarbonyl-ethyl)phenyl]-1,3-phenylenediamine, 5 ml of ethyleneglycol and 0.02 g of tetrabutoxy titanium are added into a 50 ml three-neck flask, and the mixture is stirred by heating at 200° C. for 5 hours in a nitrogen stream. After confirming that the N,N′-di(2-fruolenyl)-N,N′-bis[4-(2-methoxycarbonyl-ethyl)phenyl]-1,3-phenylenediamine has been used up, the reaction solution is heated at 210° C. while ethyleneglycol is removed by distillation under a reduced pressure of 50 Pa, and the reaction is continued for 4 hours.

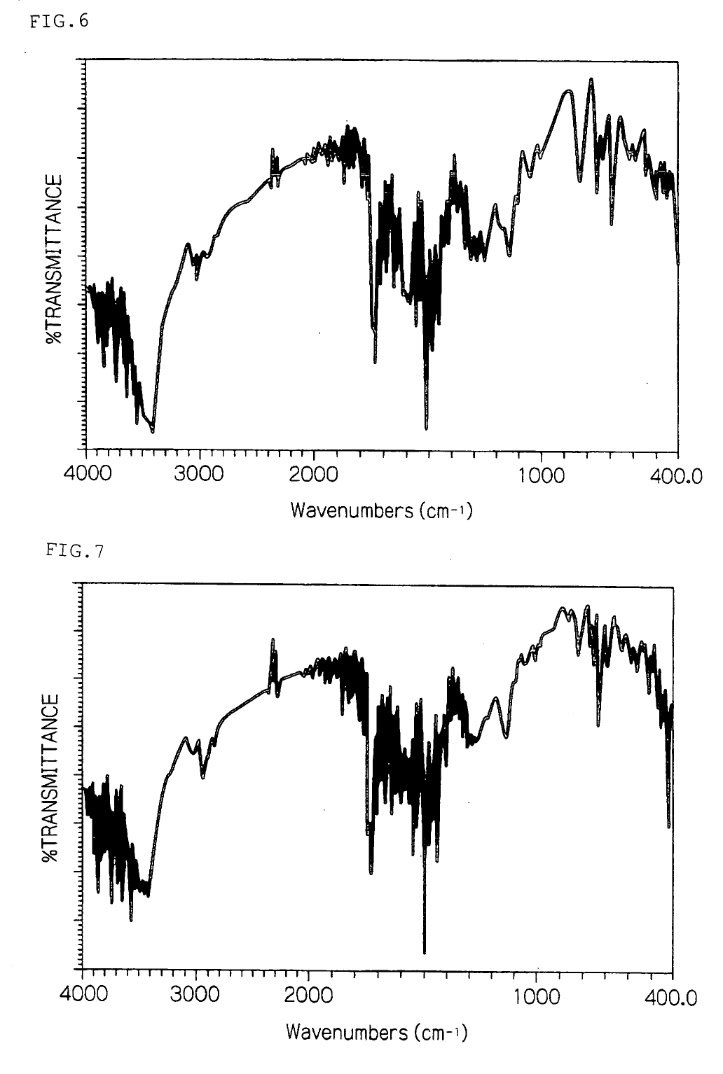

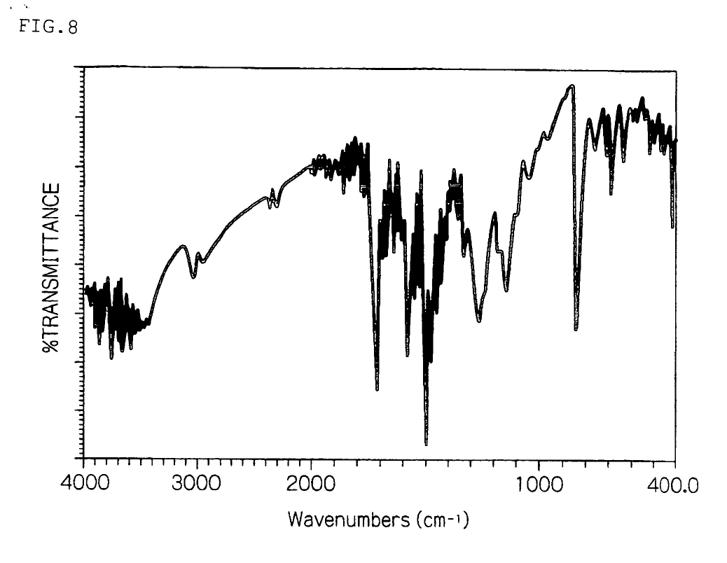

The reaction solution is cooled to room temperature thereafter, and 200 ml of tetrahydrofuran (THF) is added to dissolve the product. Impurities are filtered off with a polytetrafluoroethylene (PTFE) filter with a pore size of 0.5 μm. The filtrate is added dropwise into 500 ml of methanol with stirring to precipitate the polymer. The polymer obtained is filtered off, thoroughly washed with methanol and dried to obtain 1.0 g of polymer (16). The weight average molecular weight Mw is found to be 8.5×10⁴ (as converted into styrene) from the measurement by GPC, and the degree of polymerization (p) is about 105 as determined from the molecular weight of the monomer. The IR spectrum of this compound is shown in FIG. 7.

### Example 4

### Synthesis of Polymer[Compound (21)]

1.0 g of N,N′-di(1-pyrenyl)-N,N′-bis[4-(2-methoxycarbonylethyl)phenyl]-1,3-phenylenediamine, 5 ml of ethyleneglycol and 0.02 g of tetrabutoxy titanium are added into a 50 ml three-neck flask, and the mixture is stirred by heating at 200° C. for 7 hours in a nitrogen stream. After confirming that N,N′-di(1-pyrenyl)-N,N′-bis[4-(2-methoxycarbonyl-ethyl)phenyl]-1,3-phenylenediamine has been used up, the reaction solution is heated at 210° C. while ethyleneglycol is removed by distillation under a reduced pressure of 50 Pa, and the reaction is continued for 4 hours.

The reaction solution is cooled to room temperature thereafter, and 200 ml of tetrahydrofuran (THF) is added to dissolve the product. Impurities are filtered off with a polytetrafluoroethylene (PTFE) filter with a pore size of 0.5 μm. The filtrate is added dropwise into 500 ml of methanol with stirring to precipitate the polymer. The polymer obtained is filtered off, thoroughly washed with methanol and dried to obtain 1.0 g of polymer (21). The weight average molecular weight Mw is found to be 3.6×104 (as converted into styrene) from the measurement by GPC, and the degree of polymerization (p) is about 45 as determined from the molecular weight of the monomer. The IR spectrum of this compound is shown in FIG. 8.

Evaluation

Charge mobility of the diamine compound polymer having the 1,3-phneylene group of the invention is measured by a time-of-flight method, and the glass transition temperature is measured with a differential scanning calorimeter (DSC, trade name: DSC 6200, manufactured by SII Nanotechnology Inc.). The results are shown in the table.

In Comparative Example 1 in the table, the physical properties of MHE-PVP [poly(2-methoxy-5-(2′-ethylhexyoxy))-1,4-phenylenevinylene; weight average molecular weight (Mw)=86,000] are shown.

TABLE 10

| | | Glass Transition |
|---|---|---|
| | Charge Mobility | Temperature |
| | (cm²/V · s) | (° C.) |
| Example 1 | 7 × 10⁻⁵ | 110 |
| Example 2 | 6 × 10⁻⁵ | 120 |
| Example 3 | 8 × 10⁻⁵ | 125 |
| Example 4 | 3 × 10⁻⁵ | 150 |
| Comparative Example 1 | 10⁻⁸ to 10⁻⁷ | 75 |
| (MEH-PPV) | | |

The results in the table above show that the diamine compound polymer having the 1,3-phenylene group has a higher charge mobility than that of the conventional charge transfer material, while the glass transition temperature is as high as 100° C. or more.

What is claimed is:

1. A diamine compound polymer having a 1,3-phenylene group selected from structural formulae represented by formulae (I-1) or (I-2): 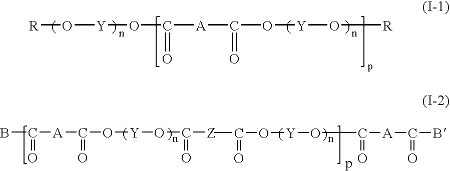
where, in the formulae (I-1) and (I-2), A represents a structure represented by the following formula (II); R represents a hydrogen atom, an alkyl group, a substituted or non-substituted aryl group, or a substituted or non-substituted aralkyl group; Y represents a divalent alcoholic residue; Z represents a divalent carboxylic acid residue; B and B′ independently represent —O—(Y—O)ₙ—R or —O—(Y—O)ₙ—CO—Z—CO—OR′ (where R, Y and Z have the same meanings as described above, and R′ represents an alkyl group, a substituted or non-substituted aryl group, or a substituted or non-substituted aralkyl group); n represents an integer of 1 to 5; and p represents an integer of 5 to 5000; 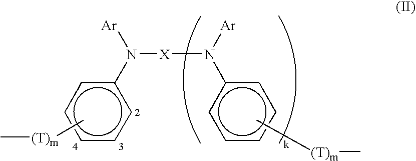
where, in the formula (II), Ar represents a substituted or non-substituted aromatic group; X represents a substituted or non-substituted divalent phenylene group; T represents a divalent linear hydrocarbon group having 1 to 6 carbon atoms or a branched hydrocarbon group having 2 to 10 carbon atoms; and k and m represent an integer of 0 or 1, respectively.

2. The diamine compound polymer having a 1,3-phenylene group of claim 1, wherein X in the formula (II) is a divalent 1,3-phenylene group selected from structural formulae represented by following structural formulae (III-1), (III-2) or (III-3): 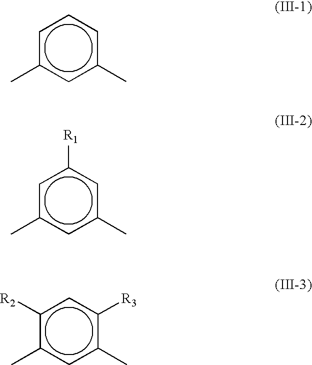
where, in formulae (III-2) and (III-3), R₁, R₂ and R₃ each independently represent a hydrogen atom, an alkyl group, a substituted or non-substituted aryl group, or a substituted or non-substituted aralkyl group.

3. The diamine compound polymer having a 1,3-phenylene group of claim 1, wherein Ar in the formula (II) is a substituted or non-substituted phenyl group, a substituted or non-substituted monovalent polynuclear aromatic hydrocarbon having 2 to 10 aromatic groups, a substituted or non-substituted monovalent condensed ring aromatic compound having 2 to 10 aromatic groups, a substituted or non-substituted monovalent aromatic heterocyclic ring, or a substituted or non-substituted monovalent aromatic group containing at least one aromatic heterocyclic ring.

4. The diamine compound polymer having a 1,3-phenylene group of claim 3, wherein a number of the aromatic rings constituting the polycyclic aromatic hydrocarbon or the condensed ring aromatic hydrocarbon is 2 to 5

5. The diamine compound polymer having a 1,3-phenylene group of claim 3, wherein the condensed ring aromatic hydrocarbon is a totally condensed ring aromatic hydrocarbon.

6. The diamine compound polymer having a 1,3-phenylene group of claim 3, wherein the polycyclic aromatic hydrocarbon is a biphenyl or a terphenyl.

7. The diamine compound polymer having a 1,3-phenylene group of claim 3, wherein the condensed ring aromatic hydrocarbon is a naphthalene, an anthracene, a phenanthrene or a fluorene.
